(19) United States
(12) Patent Application Publication
(10) Pub. No.: US 2024/0302820 A1
(43) Pub. Date: Sep. 12, 2024

(54) NUMERICAL CONTROL DEVICE

(71) Applicant: Fanuc Corporation, Minamitsuru-gun, Yamanashi (JP)

(72) Inventor: Takashi Miyoshi, Minamitsuru-gun, Yamanashi (JP)

(73) Assignee: Fanuc Corporation, Minamitsuru-gun, Yamanashi (JP)

(21) Appl. No.: 18/574,976

(22) PCT Filed: Jul. 29, 2021
(86) PCT No.: PCT/JP2021/028167

§ 371 Date: Dec. 28, 2023

(51) Int. Cl. G05B 19/416

(52) U.S. Cl. CPC G05B 19/4163; G05B 2219/50216

(57) ABSTRACT

A numerical control device includes: a first control unit which rotates a workpiece about a rotation axis of the workpiece; a second control unit which rotates a rotary tool at a rotation speed with a constant ratio with respect to the rotation speed of the workpiece about the rotation axis, of the rotary tool, parallel to the rotation axis of the workpiece; and a third control unit which controls the relative positions of the rotation axis of the rotary tool and the center axis of a polygon so that the positional relationship between the rotation axis of the rotary tool and the center axis of the polygon is fixed, and the center axis of the polygon passes through a predetermined position of the workpiece and is parallel to the rotation axis of the workpiece.

### CROSS REFERENCE TO RELATED APPLICATIONS

This is the U.S. National Phase application of PCT/JP2021/028167, filed Jul. 29, 2021, the disclosure of this application being incorporated herein by reference in its entirety for all purposes.

### FIELD OF THE INVENTION

The present disclosure relates to a numerical controller for a machine tool.

### BACKGROUND OF THE INVENTION

Conventionally, there is known a technique of machining a polygon on a workpiece surface by rotating a polygon machining tool (hereinafter, referred to as a rotary tool) and a workpiece in synchronization with each other (for example, Patent Literature 1). By utilizing this technique, it is possible to machine the polygon in a shorter time than the time required for performing a machining operation with a milling cutter.

### PATENT LITERATURE

Patent Literature 1: JP 2021-43732 A

### SUMMARY OF THE INVENTION

However, in the conventional technique, a polygon cannot be machined at a position eccentric from a rotation center of a workpiece. Therefore, it is desired to provide a technique for machining the polygon at the position eccentric from the rotation center of the workpiece in a short time.

An object of the present disclosure is to provide a numerical controller capable of machining a polygon at a position eccentric from a rotation center of a workpiece in a short time.

A numerical controller includes a first control unit configured to rotate a workpiece around a rotation axis of the workpiece, a second control unit configured to rotate a rotary tool around a rotation axis of the rotary tool at a rotation speed of a constant ratio with respect to a rotation speed of the workpiece, the rotation axis of the rotary tool being parallel to the rotation axis of the workpiece, and a third control unit configured to control a relative position between the rotation axis of the rotary tool and a center axis of a polygon so that a positional relationship between the center axis of the polygon and the rotation axis of the rotary tool is kept constant, the center axis of the polygon being parallel to the rotation axis of the workpiece and passing through a predetermined position of the workpiece.

According to one aspect of the present disclosure, it is possible to machine a polygon at a position eccentric from a rotation center of a workpiece in a short time.

### BRIEF DESCRIPTION OF DRAWINGS

FIG. 1 is a block diagram illustrating an example of a hardware configuration of a machine tool.

FIG. 2 is a diagram illustrating an example of a polygon.

FIG. 3 is a diagram illustrating an example of the polygon.

FIG. 4 is a diagram illustrating an example of a path of a cutting edge of a rotary tool with respect to a workpiece.

FIG. 5 is a diagram illustrating an example of the path of the cutting edge of the rotary tool with respect to the workpiece.

FIG. 6 is a diagram illustrating an example of a function of a numerical controller.

FIG. 7 is a diagram illustrating an initial state.

FIG. 8 is a diagram illustrating a positional relationship between a rotation axis of the rotary tool and a center axis of the polygon.

FIG. 9 is a diagram illustrating an example of a flow of processing when the numerical controller performs polygon machining.

FIG. 10A is a diagram illustrating an example of a phase of the polygon.

FIG. 10B is a diagram illustrating an example of the phase of the polygon.

FIG. 11A is a diagram illustrating an example of the phase of the polygon.

FIG. 11B is a diagram illustrating an example of the phase of the polygon.

FIG. 12 is a diagram illustrating an example of the function of the numerical controller.

FIG. 13 is a diagram illustrating an example of an initial state.

FIG. 14 is a diagram illustrating an example of the initial state.

### DETAILED DESCRIPTION OF EMBODIMENTS OF THE INVENTION

Hereinafter, embodiments of the present disclosure will be described with reference to the drawings. It is noted that not all combinations of features described in the following embodiments are necessarily required for solving the problem. Further, an unnecessarily detailed description may be omitted. The following description of the embodiments and the drawings are provided for those skilled in the art to fully understand the present disclosure, and are not intended to limit the scope of the claims.

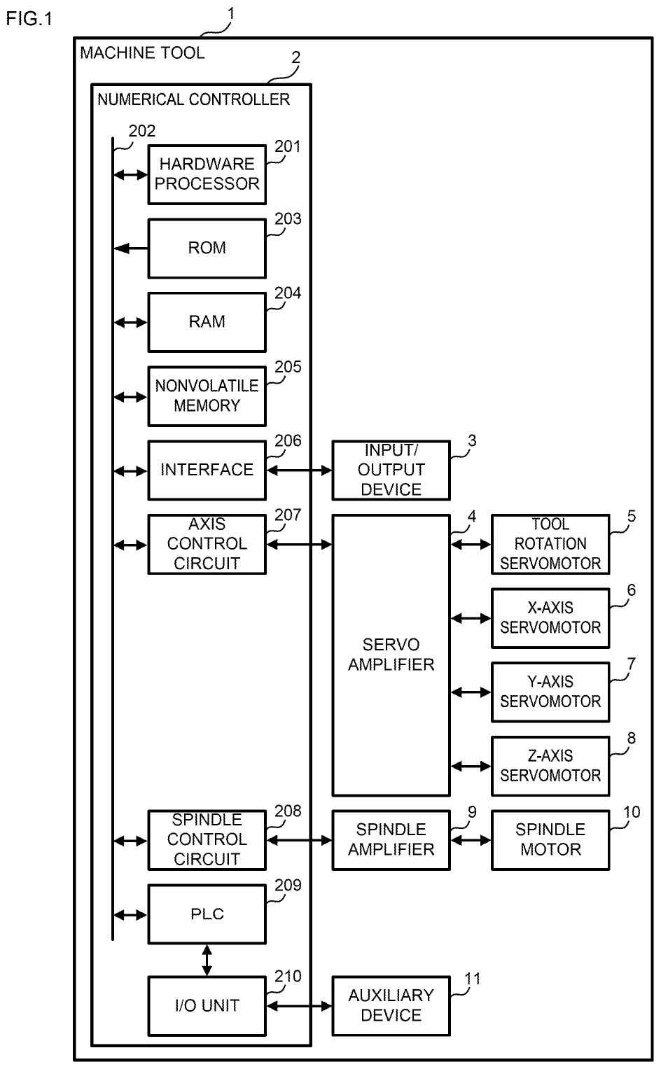

FIG. 1 is a block diagram illustrating an example of a hardware configuration of a machine tool including a numerical controller. A machine tool 1 includes a lathe, a machining center, and a multi-tasking machine.

The machine tool 1 includes a numerical controller 2, an input/output device 3, a servo amplifier 4, a tool rotation servomotor 5, an X-axis servomotor 6, a Y-axis servomotor 7, a Z-axis servomotor 8, a spindle amplifier 9, a spindle motor 10, and an auxiliary device 11.

The numerical controller 2 is a device that controls the entire machine tool 1. The numerical controller 2 includes a hardware processor 201, a bus 202, a read only memory (ROM) 203, a random access memory (RAM) 204, and a nonvolatile memory 205.

The hardware processor 201 is a processor that controls the entire numerical controller 2 according to a system program. The hardware processor 201 reads the system program and the like stored in the ROM 203 via the bus 202, and performs various types of processing based on the system program. The hardware processor 201 controls the tool rotation servomotor 5, the X-axis servomotor 6, the Y-axis servomotor 7, the Z-axis servomotor 8, and the spindle motor 10 based on a machining program. The hardware processor 201 is, for example, a central processing unit (CPU) or an electronic circuit.

The hardware processor 201, for example, analyzes the machining program and outputs a control command to the tool rotation servomotor 5, the X-axis servomotor 6, the Y-axis servomotor 7, the Z-axis servomotor 8, and the spindle motor 10 for each control cycle.

The bus 202 is a communication path that connects the pieces of hardware in the numerical controller 2 to each other. The pieces of hardware in the numerical controller 2 exchange data via the bus 202.

The ROM 203 is a storage device that stores the system program and the like for controlling the entire numerical controller 2. The ROM 203 is a computer-readable storage medium.

The RAM 204 is a storage device that temporarily stores various data. The RAM 204 functions as a work area in which the hardware processor 201 processes various data.

The nonvolatile memory 205 is a storage device that retains data even in a state where the machine tool 1 is powered off and no power is supplied to the numerical controller 2. The nonvolatile memory 205 stores, for example, the machining program and various parameters. The nonvolatile memory 205 is a computer-readable storage medium. The nonvolatile memory 205 includes, for example, a solid state drive (SSD).

The numerical controller 2 further includes an interface 206, an axis control circuit 207, a spindle control circuit 208, a programmable logic controller (PLC) 209, and an I/O unit 210.

The interface 206 connects the bus 202 to the input/output device 3. The interface 206 transmits, for example, various data processed by the hardware processor 201 to the input/output device 3.

The input/output device 3 is a device that receives various data via the interface 206 and displays the various data. In addition, the input/output device 3 accepts inputs of various data and transmits the various data to the hardware processor 201 via the interface 206. The input/output device 3 is, for example, a touch panel. When the input/output device 3 is a touch panel, the touch panel is, for example, a capacitive touch panel. The touch panel is not limited to the capacitive touch panel, and may also be another type of touch panel. The input/output device 3 is installed, for example, on an operation panel (not illustrated) in which the numerical controller 2 is housed.

The axis control circuit 207 is a circuit that controls the tool rotation servomotor 5, the X-axis servomotor 6, the Y-axis servomotor 7, and the Z-axis servomotor 8. In response to receiving a control command from the hardware processor 201, the axis control circuit 207 outputs, to the servo amplifier 4, various commands for driving the tool rotation servomotor 5, the X-axis servomotor 6, the Y-axis servomotor 7, and the Z-axis servomotor 8. For example, the axis control circuit 207 transmits, to the servo amplifier 4, a torque command for controlling the torque of the tool rotation servomotor 5, the X-axis servomotor 6, the Y-axis servomotor 7, and the Z-axis servomotor 8.

In response to receiving a command from the axis control circuit 207, the servo amplifier 4 supplies a current to the tool rotation servomotor 5, the X-axis servomotor 6, the Y-axis servomotor 7, and the Z-axis servomotor 8.

The tool rotation servomotor 5 is driven by the current supplied from the servo amplifier 4. The tool rotation servomotor 5 is connected to, for example, a shaft of a rotary tool installed on a tool post. The tool rotation servomotor 5 is driven to rotate the rotary tool. The rotary tool is, for example, a polygon cutter.

The X-axis servomotor 6 is driven by the current supplied from the servo amplifier 4. The X-axis servomotor 6 is connected to, for example, a ball screw that drives a tool post. When the X-axis servomotor 6 is driven, a structure of the machine tool 1 such as a tool post moves in the X-axis direction. It is noted that the X-axis servomotor 6 may include a speed detector (not illustrated) that detects a feed rate along the X axis.

The Y-axis servomotor 7 is driven by the current supplied from the servo amplifier 4. The Y-axis servomotor 7 is connected to, for example, a ball screw that drives a tool post. When the Y-axis servomotor 7 is driven, a structure of the machine tool 1 such as a tool post moves in the Y-axis direction. It is noted that the Y-axis servomotor 7 may include a speed detector (not illustrated) that detects a feed rate along the Y axis.

The Z-axis servomotor 8 is driven by the current supplied from the servo amplifier 4. The Z-axis servomotor 8 is connected to, for example, a ball screw that drives a tool post. When the Z-axis servomotor 8 is driven, a structure of the machine tool 1 such as a tool post moves in the Z-axis direction. It is noted that the Z-axis servomotor 8 may include a speed detector (not illustrated) that detects a feed rate along the Z axis.

The spindle control circuit 208 is a circuit for controlling the spindle motor 10. In response to receiving a control command from the hardware processor 201, the spindle control circuit 208 outputs a command for driving the spindle motor 10 to the spindle amplifier 9. The spindle control circuit 208 transmits, for example, a torque command for controlling the torque of the spindle motor 10 to the spindle amplifier 9.

In response to receiving a command from the spindle control circuit 208, the spindle amplifier 9 supplies a current to the spindle motor 10.

The spindle motor 10 is driven by the current supplied from the spindle amplifier 9. The spindle motor 10 is connected to a spindle and rotates the spindle. The spindle motor 10 includes an angle detector (not illustrated) that detects a rotation angle of the spindle.

The PLC 209 is a device that executes a ladder program to control the auxiliary device 11. The PLC 209 transmits a command to the auxiliary device 11 via the I/O unit 210.

The I/O unit 210 is an interface that connects the PLC 209 and the auxiliary device 11. The I/O unit 210 transmits the command received from the PLC 209 to the auxiliary device 11.

The auxiliary device 11 is a device installed in the machine tool 1 and configured to perform an auxiliary operation in the machine tool 1. The auxiliary device 11 operates based on the command received from the I/O unit 210. The auxiliary device 11 may be a device installed around the machine tool 1. The auxiliary device 11 is, for example, a tool changer, a cutting fluid injection device, or an opening/closing door drive device.

Next, a function of the numerical controller 2 will be described. The numerical controller 2 performs polygon machining by controlling the tool rotation servomotor 5, the X-axis servomotor 6, the Y-axis servomotor 7, the Z-axis servomotor 8, and the spindle motor 10. The polygon machining is machining to form a cross-sectional shape of a workpiece into a polygon. Here, the cross section is a cross section orthogonal to the rotation axis of the workpiece. Particularly, the numerical controller 2 performs machining to form a polygon at a position eccentric from the rotation axis of the workpiece.

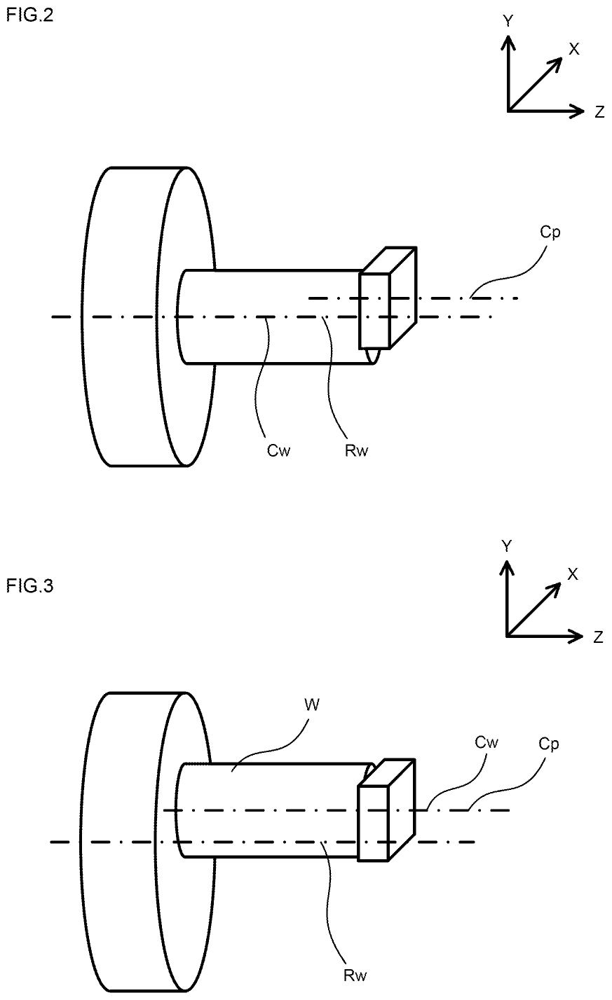

FIG. 2 is a diagram illustrating an example of a polygon formed at a position eccentric from a rotation axis of a workpiece. A rotation axis Rw of a workpiece is a rotation center of the workpiece. That is, a center axis Cp of the polygon is located at a position shifted from the rotation axis Rw of the workpiece, in other words, at a position different from the rotation axis Rw of the workpiece.

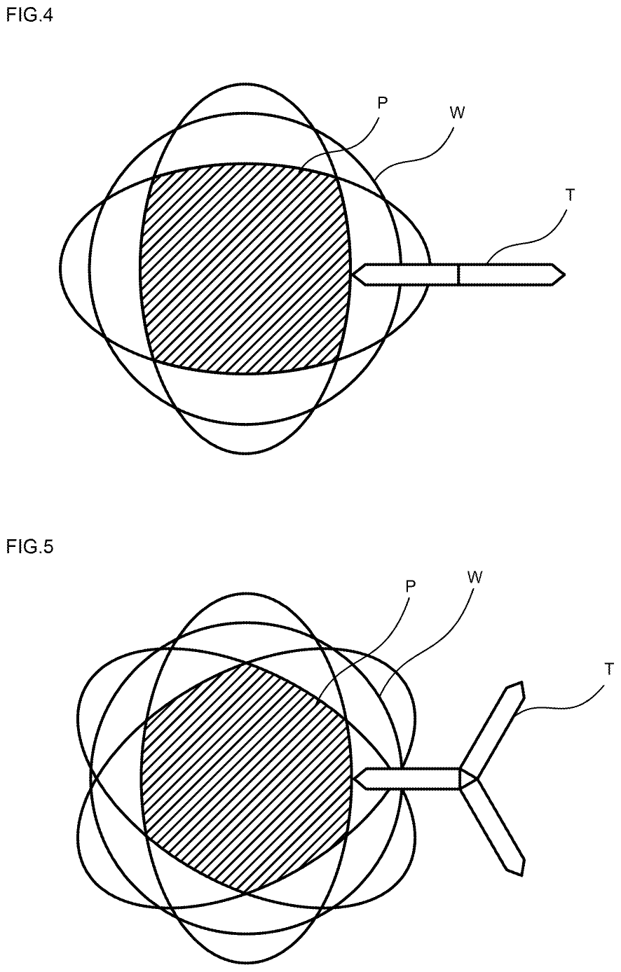

In the example illustrated in FIG. 2, a center axis Cw of the workpiece and the rotation axis Rw of the workpiece coincide with each other, but the center axis Cw and the rotation axis Rw do not necessarily coincide with each other. For example, as illustrated in FIG. 3, when the workpiece W is gripped by an eccentric chuck at a position eccentric from the rotation axis Rw of the workpiece, the center axis Cw of the workpiece does not coincide with the rotation axis Rw of the workpiece.

The numerical controller 2 rotates both the workpiece W and the rotary tool at a constant rotation speed ratio while keeping the relative position between the center axis Cp of the polygon and the rotation axis Rt of the rotary tool constant. In this way, the polygon is machined on the surface of the workpiece W. For example, when the rotation speed ratio of the workpiece W and the rotary tool is 1:2, a relative path of a cutting edge of the rotary tool with respect to the workpiece W is expressed by the following Mathematical Formula 1.

$$\begin{matrix}{x}_{n} = l \times cos ( ω t ) + r \times cos ( ω t + 2 π \times n / N ) \\ {y}_{n} = - l \times sin ( ω t ) + r \times sin ( ω t + 2 π \times n / N )\end{matrix} \qquad [ Mathematical formula 1 ]$$

Here, Xn and Yn are paths of the cutting edge in an orthogonal coordinate system with the center axis Cp of the polygon as an origin, @ is the rotation speed of the workpiece W, l is a distance between the center axis Cp of the polygon and the rotation axis of the rotary tool, r is a radius of the rotary tool, N is the number of blades of the rotary tool, and n (=1 to N) is a number of the cutting edge. The number of the cutting edge is a number given to each cutting edge in order from 1 in order to identify each cutting edge of a rotary tool T.

FIG. 4 is a diagram illustrating a path of a cutting edge of a rotary tool with respect to the workpiece W when the rotation speed ratio between the workpiece W and the rotary tool is 1:2 and polygon machining is performed using a rotary tool having two blades. In this example, the rotary tool T makes two rotations while the workpiece W makes one rotation. The path of each blade of the rotary tool T draws an ellipse, and the major axes of the respective ellipses are orthogonal to each other. Therefore, as illustrated in FIG. 4, a polygon P having four surfaces is formed on the workpiece W.

FIG. 5 is a diagram illustrating a path of the cutting edge of the rotary tool T with respect to the workpiece W when the rotation speed ratio between the workpiece W and the rotary tool T is 1:2 and polygon machining is performed using the rotary tool T having three blades. In this example, the rotary tool T makes two rotations while the workpiece W makes one rotation. Further, the path of each blade of the rotary tool T draws an ellipse, and the major axes of the respective ellipses intersect each other at the angle of 120°. Therefore, as illustrated in FIG. 5, the polygon P having six surfaces is formed on the workpiece W. Here, as an example, a description has been given as to machining when the rotation speed ratio between the workpiece W and the rotary tool T is 1:2, but a polygon is formed as long as the product of the ratio of the rotation speed of the rotary tool T to the rotation speed of the workpiece W and the number of blades is an integer of three or more.

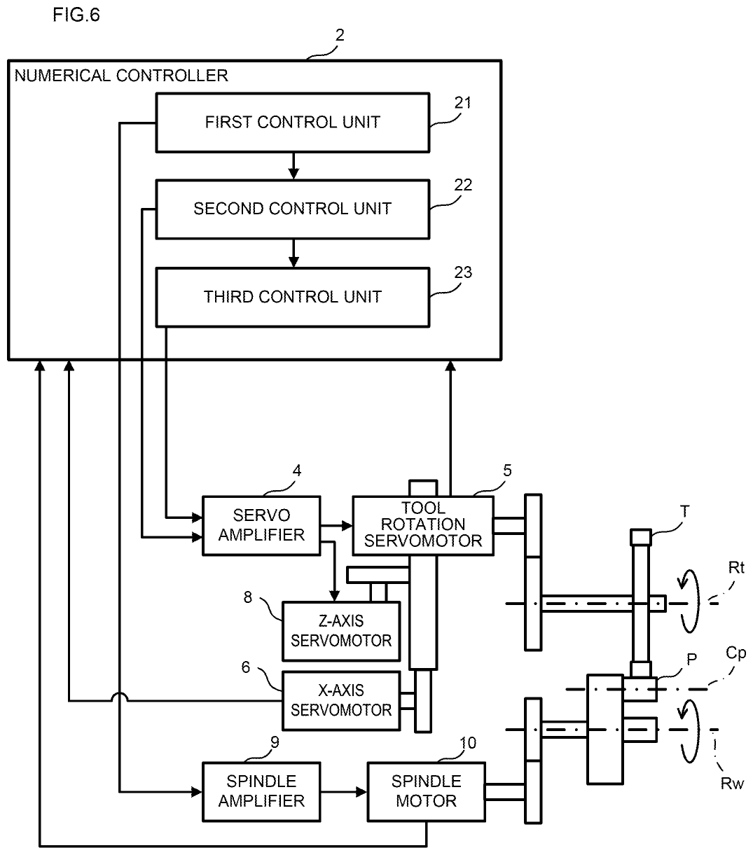

FIG. 6 is a block diagram illustrating an example of a function of the numerical controller 2. The numerical controller 2 includes a first control unit 21, a second control unit 22, and a third control unit 23. The first control unit 21, the second control unit 22, and the third control unit 23 are implemented, for example, by allowing the hardware processor 201 to execute arithmetic processing using the system program stored in the ROM 203, the machining program and various data stored in the nonvolatile memory 205.

The first control unit 21 controls the spindle motor 10 to move the center axis Cp of the polygon to the initial position before polygon machining is started. Before the machining of the polygon P is started, the second control unit 22 controls the tool rotation servomotor 5 to move the blade of the rotary tool T to the initial position. In other words, the second control unit 22 adjusts the phase of the rotary tool T to the initial phase. The third control unit 23 controls at least one of the X-axis servomotor 6 and the Y-axis servomotor 7 (not illustrated in FIG. 6) to move the rotation axis Rt of the rotary tool to the initial position so that a positional relationship between the center axis Cp of the polygon and the rotation axis Rt of the rotary tool becomes a predetermined positional relationship. Each of the rotation axis Rt of the rotary tool and the rotation axis Rw of the workpiece may be driven by the spindle motor 10 or may be driven by a servomotor.

Hereinafter, a state in which the center axis Cp of the polygon is disposed at the initial position, a state in which the phase of the rotary tool T is the initial phase, and a state in which the positional relationship between the center axis Cp of the polygon and the rotation axis Rt of the rotary tool is a predetermined positional relationship at the start of machining of the polygon P are referred to as initial states.

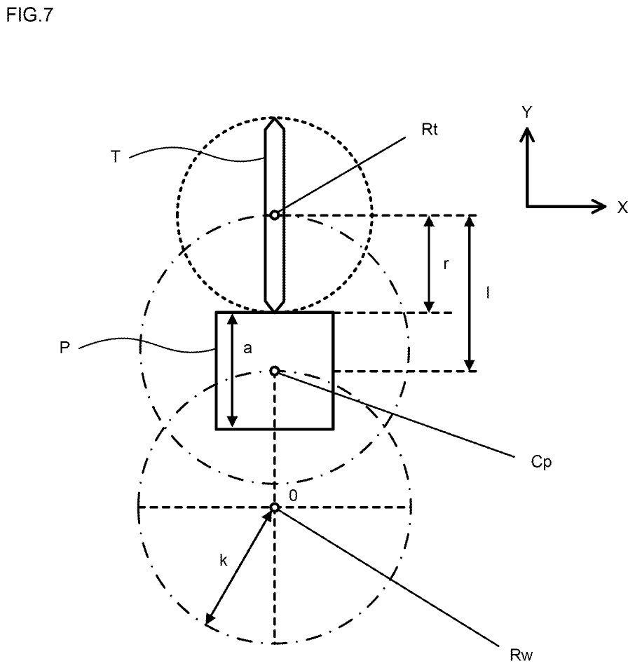

FIG. 7 is a diagram illustrating an initial state. Here, the initial state will be described using a two-dimensional orthogonal coordinate system in which the rotation axis Rw of the workpiece is the origin, the right direction is the positive direction of the X axis, and the upper direction is the positive direction of the Y axis for convenience.

The initial position of the center axis Cp of the polygon is, for example, a position at which the X coordinate is 0 and the Y coordinate is k. Here, k is a distance between the rotation axis Rw of the workpiece and the center axis Cp of the polygon. The initial phase of the rotary tool T is, for example, a phase in which one blade faces the direction of the center axis Cp of the polygon. Further, a position at which the center axis Cp of the polygon and the rotation axis Rt of the rotary tool have a predetermined positional relationship is, for example, a position at which the X coordinate of the rotation axis Rt of the rotary tool is 0 and the Y coordinate is k+1. In other words, the position at which the center axis Cp of the polygon and the rotation axis Rt of the rotary tool have the predetermined positional relationship is a position at which the initial position of the center axis Cp of the polygon is disposed on a line segment connecting the initial position of the rotation axis Rw of the workpiece to the initial position of the rotation axis Rt of the rotary tool. It is noted that 1 is a value obtained by multiplying a value obtained by adding a diameter 2r of the rotary tool T and a distance a between a pair of surfaces of the polygon P by ½.

When the center axis Cp of the polygon, the phase of the rotary tool T, and the positional relationship between the center axis Cp of the polygon and the rotation axis Rt of the rotary tool are in the initial state, the first control unit 21, for example, rotates the workpiece W around the rotation axis Rw of the workpiece by controlling the spindle motor 10. The rotation axis Rw of the workpiece is, for example, a center axis of a spindle. The rotation axis Rw of the workpiece may be the center of a shaft connected to a rotary table.

For example, when the first control unit 21 rotates the spindle in a state in which the workpiece W is held by a chuck connected to the spindle, the first control unit 21 rotates the workpiece W around the rotation axis Rw of the workpiece.

The second control unit 22 rotates the rotary tool T around the rotation axis Rt of the rotary tool parallel to the rotation axis Rw of the workpiece at a rotation speed of a constant ratio with respect to the rotation speed of the workpiece W.

For example, the second control unit 22 rotates the rotary tool T at a speed twice as fast as the rotation speed of the workpiece W. That is, the second control unit 22 rotates the rotary tool T so that the rotation speed ratio between the workpiece W and the rotary tool T is set to 1:2. For example, this case uses the rotary tool T having two blades respectively disposed at different positions and separated from each other by 180° around the rotation axis Rt of the rotary tool T. Alternatively, it may be possible to use the rotary tool T having three blades respectively disposed at different positions and separated from each other by 120° around the rotation axis Rt of the rotary tool T.

The rotation speed ratio of the workpiece W and the rotary tool T and the number of blades of the rotary tool T are not limited to these examples. The rotation speed ratio of the workpiece W and the rotary tool T and the number of blades of the rotary tool T are determined depending on the shape of the polygon P to be formed.

The third control unit 23 controls the relative position between the rotation axis Rt of the rotary tool and the center axis Cp of the polygon so that the positional relationship between the center axis Cp of the polygon that is parallel to the rotation axis Rw of the workpiece and passes through a predetermined position of the workpiece W and the rotation axis Rt of the rotary tool is kept constant.

In the present embodiment, the position of the rotation axis Rw of the workpiece is fixed. Therefore, the third control unit 23 controls the relative position between the rotation axis Rt of the rotary tool and the center axis Cp of the polygon by controlling the position of the rotation axis Rt of the rotary tool. However, the position of the rotation axis Rt of the rotary tool may be fixed, and the position of the rotation axis Rw of the workpiece may be movable. In this case, the third control unit 23 controls the positional relationship between the rotation axis Rt of the rotary tool and the center axis Cp of the polygon by controlling the position of the rotation axis Rw of the workpiece.

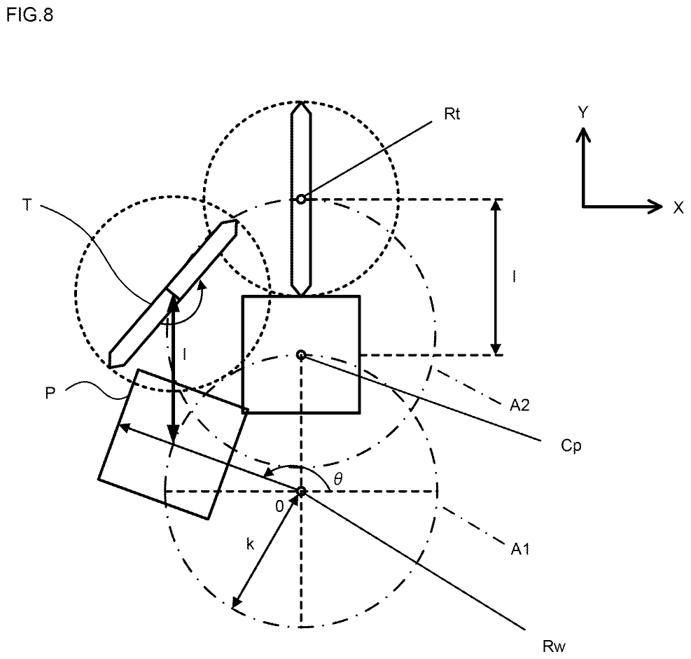

FIG. 8 is a diagram illustrating a positional relationship between the rotation axis Rt of the rotary tool and the center axis Cp of the polygon. In the example illustrated in FIG. 8, the X coordinate of the center axis Cp of the polygon and the X coordinate of the rotation axis Rt of the rotary tool are always the same. The Y coordinate of the rotation axis Rt of the rotary tool is always a value obtained by adding 1 to the Y coordinate of the center axis Cp of the polygon. That is, assuming that a path along which the center axis Cp of the polygon moves is defined as (Xt, Yt), a path along which the rotation axis Rt of the rotary tool moves can be represented as (Xt, Yt+1). The center coordinates of the path along which the rotation axis Rt of the rotary tool moves are (0, 1).

The third control unit 23 controls the relative position between the rotation axis Rt of the rotary tool and the center axis Cp of the polygon so that the positional relationship between the center axis Cp of the polygon and the rotation axis Rt of the rotary tool is kept constant, thereby machining the polygon P. The polygon P is machined around the center axis Cp of the polygon, which passes through a predetermined position separated from the rotation axis Rw of the workpiece by k. The center axis Cp of the polygon moves on the circumference of a circle A1 with a radius k having the rotation axis Rw of the workpiece as a center thereof when the workpiece W rotates. The third control unit 23 moves the rotation axis Rt of the rotary tool on the circumference of a circle A2 with a radius k so that the relative position between the rotation axis Rt of the rotary tool and the center axis Cp of the polygon becomes constant.

The third control unit 23 may identify the position of the center axis Cp of the polygon with respect to the position of the rotation axis Rw of the workpiece based on a rotation angle θ of the rotation axis Rw of the workpiece and a distance between the rotation axis Rw of the workpiece and the center axis Cp of the polygon. The rotation angle θ of the rotation axis Rw of the workpiece is an angle between a portion indicating a positive value of the X axis and a line segment connecting the rotation axis Rw of the workpiece and the origin in an orthogonal coordinate system having the rotation axis Rw of the workpiece as the origin.

The third control unit 23 calculates the rotation angle θ of the rotation axis Rw of the workpiece based on, for example, information detected by an angle detector installed in the spindle motor 10. In addition, for example, the third control unit 23 reads, from the machining program, a value indicating the distance between the rotation axis Rw of the workpiece and the center axis Cp of the polygon.

Accordingly, the third control unit 23 identifies the position of the center axis Cp of the polygon with respect to the position of the rotation axis Rw of the workpiece. The third control unit 23 may control the relative position between the center axis Cp of the polygon and the rotation axis Rt of the rotary tool using a feedback value of the rotation angle θ of the rotation axis Rw of the workpiece.

When machining of the polygon P is started, the third control unit 23 may cause the rotation axis Rt of the rotary tool to be close to the center axis Cp of the polygon by cutting feed until the positional relationship between the center axis Cp of the polygon and the rotation axis Rt of the rotary tool becomes a positional relationship in the initial state.

Alternatively, when moving the position of the rotation axis Rt of the rotary tool to the initial position, the third control unit 23 may position the rotary tool T, for example, at a position separated from one end of the workpiece W by a predetermined distance in the Z-axis direction so that the rotary tool T does not come into contact with a part of the workpiece W. In this case, the rotary tool T moves in the Z-axis direction to machine the polygon P.

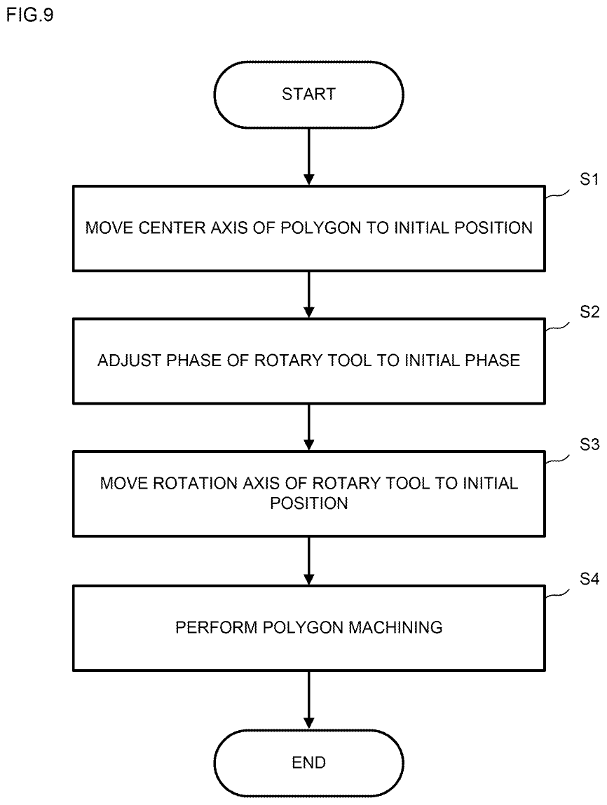

Next, a flow of processing when polygon machining is performed will be described with reference to FIG. 9.

FIG. 9 is a diagram illustrating an example of a flow of processing when the numerical controller 2 performs polygon machining.

First, the first control unit 21 moves the center axis Cp of the polygon to a predetermined initial position (step S1).

Next, the second control unit 22 adjusts the phase of the rotary tool T to a predetermined initial phase (step S2).

Next, the third control unit 23 moves the rotation axis Rt of the rotary tool to the initial position based on the position of the center axis Cp of the polygon with respect to the position of the rotation axis Rw of the workpiece (step S3).

Next, polygon machining is performed (step S4), and when the polygon machining is completed, the processing ends. In the polygon machining, the first control unit 21 rotates the workpiece W, and the second control unit 22 rotates the rotary tool T. The first control unit 21 and the second control unit 22 respectively rotate the workpiece W and the rotary tool T so that the rotation speed of the workpiece W and the rotation speed of the rotary tool T have a constant ratio.

In addition, the third control unit 23 controls the position of the rotation axis Rt of the rotary tool so that the relative position between the rotation axis Rt of the rotary tool and the center axis Cp of the polygon becomes constant. Further, the rotary tool T is moved by cutting feed in, for example, a negative direction or a positive direction of the Z axis. As a result, for example, the polygon P having a surface extending in the horizontal direction in a state where the workpiece W is disposed at the initial position is formed.

As described above, the numerical controller 2 includes the first control unit 21 that rotates the workpiece W around the rotation axis Rw of the workpiece, the second control unit 22 that rotates the rotary tool T around the rotation axis Rt of the rotary tool parallel to the rotation axis Rw of the workpiece at a rotation speed of a constant ratio with respect to a rotation speed of the workpiece W, and the third control unit 23 that controls a relative position between the rotation axis Rt of the rotary tool and the center axis Cp of the polygon so that a positional relationship between the center axis Cp of the polygon that is parallel to the rotation axis Rw of the workpiece and passes through a predetermined position of the workpiece W and the rotation axis Rt of the rotary tool is kept constant. Therefore, the numerical controller 2 can machine the polygon P in a short time at a position eccentric from the rotation center of the workpiece W.

Further, the third control unit 23 identifies the position of the center axis Cp of the polygon with respect to the position of the rotation axis Rw of the workpiece based on the rotation angle θ of the rotation axis Rw of the workpiece and the distance between the rotation axis Rw of the workpiece and the center axis Cp of the polygon, and determines the initial position of the rotation axis Rt of the rotary tool so that the initial position of the center axis Cp of the polygon is disposed on a line segment connecting the initial position of the rotation axis Rw of the workpiece to the initial position of the rotation axis Rt of the rotary tool. Furthermore, the third control unit 23 uses the feedback value of the rotation angle θ of the rotation axis Rw of the workpiece to control the relative position between the center axis Cp of the polygon and the rotation axis Rt of the rotary tool. Accordingly, the third control unit 23 can accurately control the relative position between the center axis Cp of the polygon and the rotation axis Rt of the rotary tool. As a result, the numerical controller 2 can machine the polygon P with high accuracy.

In the above-described embodiment, the position of the rotation axis Rw of the workpiece is fixed. Therefore, the third control unit 23 controls the relative position between the rotation axis Rt of the rotary tool and the center axis Cp of the polygon by controlling the position of the rotation axis Rt of the rotary tool. However, the position of the rotation axis Rt of the rotary tool may be fixed, and the position of the rotation axis Rw of the workpiece may be movable. In this case, the third control unit 23 controls the relative position between the rotation axis Rt of the rotary tool and the center axis Cp of the polygon by controlling the position of the rotation axis Rw of the workpiece. In addition, the third control unit 23 determines the initial position of the rotation axis Rw of the workpiece so that the initial position of the center axis Cp of the polygon is disposed on a line segment connecting the initial position of the rotation axis Rw of the workpiece to the position of the rotation axis Rt of the rotary tool.

In order to move the rotation axis Rw of the workpiece, the X-axis servomotor 6 and the Y-axis servomotor 7 may freely move a headstock on the X-Y plane.

In addition, the third control unit 23 may control both the position of the rotation axis Rw of the workpiece and the position of the rotation axis Rt of the rotary tool so that a relative position between the center axis Cp of the polygon and the rotation axis Rt of the rotary tool is kept constant.

Furthermore, the numerical controller 2 may further include a setting unit that sets a phase of the polygon P formed around the center axis Cp of the polygon, and the third control unit 23 may determine, based on the phase set by the setting unit, the relative position between the rotation axis Rt of the rotary tool and the center axis Cp of the polygon.

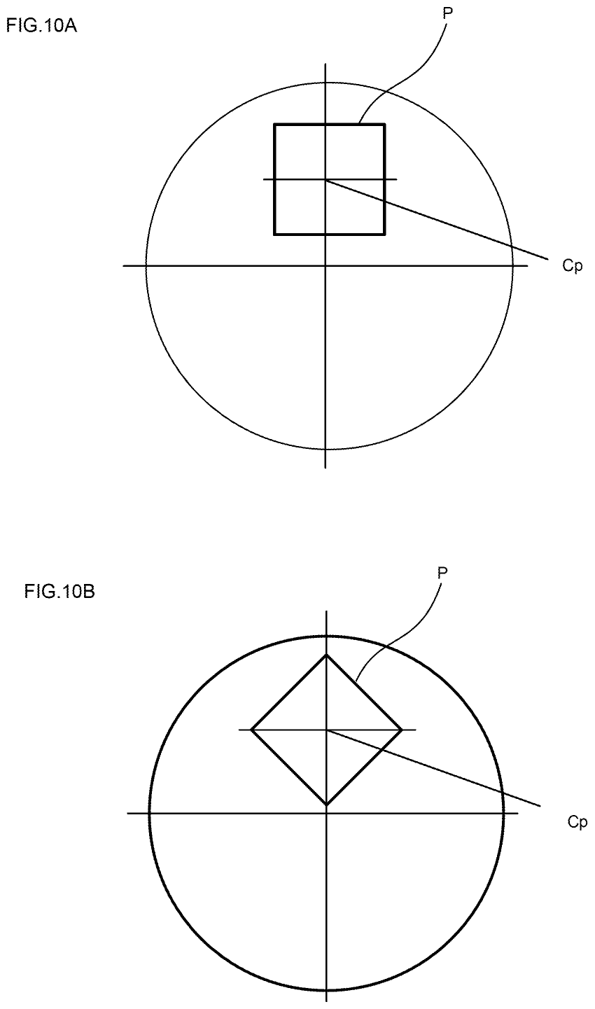

FIG. 10A is a diagram illustrating an example of the phase of the polygon P. When the setting unit sets the phase to 0° and the polygon P is machined by the rotary tool T having two blades, the polygon P illustrated in FIG. 10A is formed. That is, the quadrangular polygon P having surfaces formed horizontally and vertically is formed in a state where the center axis Cp of the polygon is disposed on the Y axis.

When the setting unit sets the phase to 45° and the polygon P is machined by the rotary tool T having two blades, the polygon P illustrated in FIG. 10B is formed. That is, the quadrangular polygon P having surfaces inclined at 45° and 135° with respect to the horizontal plane is formed in a state where the center axis Cp of the polygon is disposed on the Y axis. It is noted that the phase set by the setting unit is not limited to these values, and may be any value.

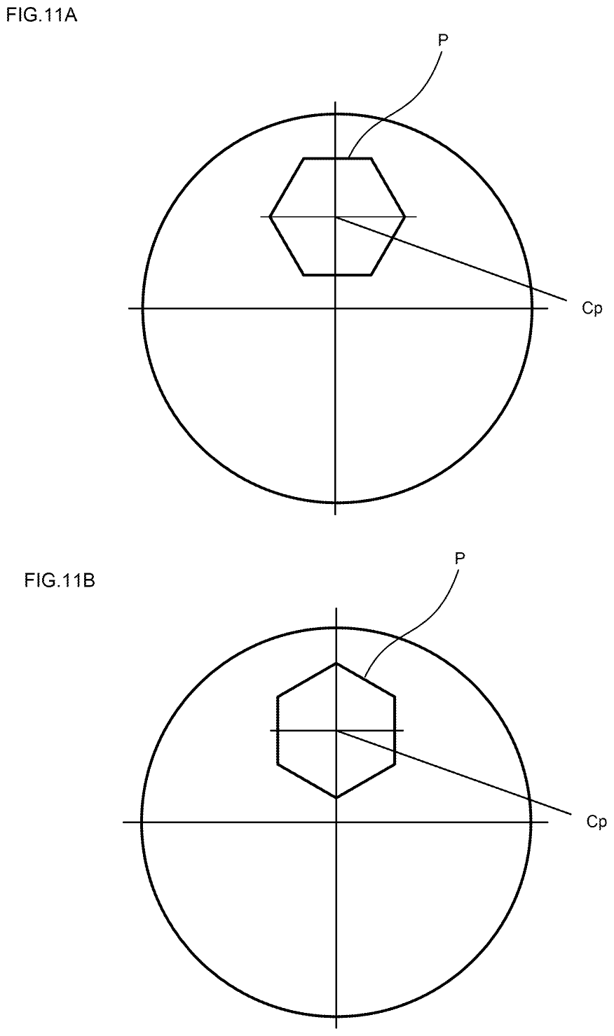

FIG. 11A is a diagram illustrating an example of the phase of the polygon P. When the setting unit sets the phase to 0° and the polygon P is machined by the rotary tool T having three blades, the polygon P illustrated in FIG. 11A is formed. That is, the hexagonal polygon P having horizontally formed surfaces is formed in a state where the center axis Cp of the polygon is disposed on the Y axis.

When the setting unit sets the phase to 120° and the polygon P is machined by the rotary tool T having three blades, the polygon P illustrated in FIG. 11B is formed. That is, the hexagonal polygon P having surfaces inclined by 120° with respect to a horizontal plane is formed in a state where the center axis Cp of the polygon is disposed on the Y axis.

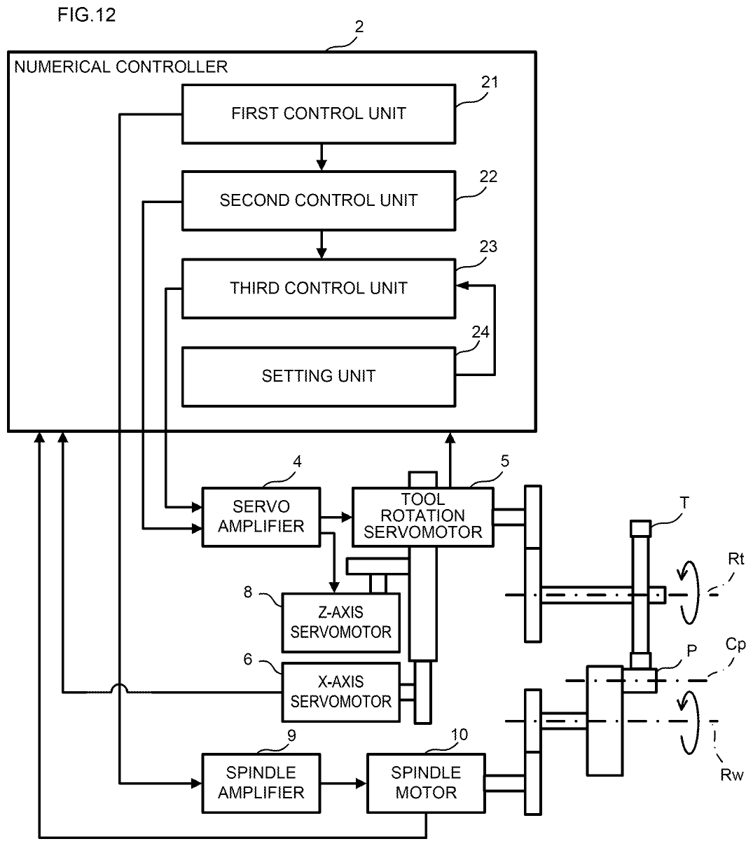

FIG. 12 is a diagram illustrating an example of a function of the numerical controller 2 including the setting unit. The same functions as those of the numerical controller 2 illustrated in FIG. 6 will not be described here.

A setting unit 24 sets the phase of the polygon P formed on the workpiece W. For example, the setting unit 24 determines the phase of the polygon P based on an input value input from the input/output device 3.

The first control unit 21 moves the center axis Cp of the polygon to a predetermined initial position before machining of the polygon P is started. Before the machining of the polygon P is started, for example, the second control unit 22 determines the initial phase of the rotary tool T so as to allow one blade to face the direction of the center axis Cp of the polygon. Before the machining of the polygon P is started, the third control unit 23 moves the rotation axis Rt of the rotary tool to the initial position so that a positional relationship between the center axis Cp of the polygon and the rotation axis Rt of the rotary tool becomes a predetermined positional relationship.

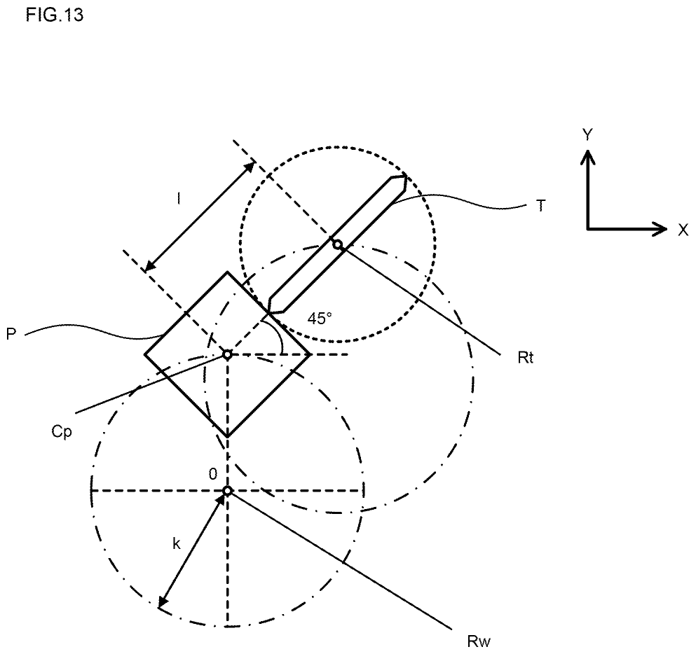

FIG. 13 is a diagram illustrating an example of the initial state of the center axis Cp of the polygon, the position of the rotation axis Rt of the rotary tool, and the phase of the rotary tool T. The initial position of the center axis Cp of the polygon is, for example, a position at which the X coordinate is 0 and the Y coordinate is k.

For example, when the setting unit 24 sets the phase to 45°, the third control unit 23 determines, as the initial position, a position that is 45° obliquely above the position of the center axis Cp of the polygon and at which a distance between the center axis Cp of the polygon and the rotation axis Rt of the rotary tool becomes l. Here, l is a value obtained by multiplying a value obtained by adding a diameter of the rotary tool T and a distance between a pair of surfaces of the polygon P by ½. In addition, the second control unit 22 determines the initial phase of the rotary tool T to be a phase in which the cutting edge of one blade faces obliquely downwards by 45°.

While the polygon P is machined, the third control unit 23 controls the position of the rotation axis Rt of the rotary tool so that a relative position between the center axis Cp of the polygon and the rotation axis Rt of the rotary tool is kept constant. As a result, machining is performed on the polygon P having a shape reflecting the phase of the polygon P set by the setting unit 24.

It is noted that the numerical controller 2 may include the setting unit 24 that sets the phase of the polygon P formed around the center axis Cp of the polygon, and the second control unit 22 may determine the initial phase of the rotary tool T based on the phase set by the setting unit 24.

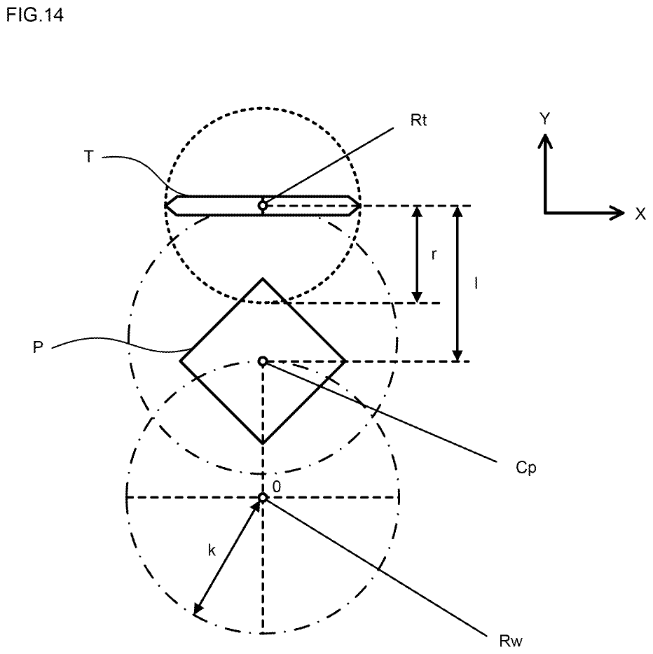

FIG. 14 is a diagram illustrating an example of the initial state of the center axis Cp of the polygon, the position of the rotation axis Rt of the rotary tool, and the phase of the rotary tool T. The first control unit 21 moves the center axis Cp of the polygon to a predetermined initial position before machining of the polygon P is started. The initial position of the center axis Cp of the polygon is, for example, a position at which the X coordinate is 0 and the Y coordinate is k.

The third control unit 23 moves the rotation axis Rt of the rotary tool to the initial position before the machining of the polygon P is started. The initial position of the rotation axis Rt of the rotary tool is, for example, a position at which the X coordinate is 0 and the Y coordinate is k+1.

The second control unit 22 rotates the rotary tool T so that the rotary tool T becomes the initial phase before machining of the polygon P is started. The second control unit 22 determines the initial position of a blade of the rotary tool T based on a value indicating the phase of the polygon P set by the setting unit 24.

For example, in a case where the rotation speed ratio between the workpiece W and the rotary tool T is set to 1:2 and the rotary tool T having two blades is used, when the setting unit 24 sets the phase to 45°, the second control unit 22 determines the initial position of the blade of the rotary tool T as a position at which the cutting edge of one blade faces the horizontal direction.

While the polygon P is machined, the third control unit 23 controls the position of the rotation axis Rt of the rotary tool so that a relative position between the center axis Cp of the polygon and the rotation axis Rt of the rotary tool is kept constant. As a result, machining is performed on the polygon P having a shape reflecting the phase of the polygon P set by the setting unit 24.

In the embodiment described above, the numerical controller 2 determines the position of the rotation axis Rt of the rotary tool or the initial phase of the rotary tool T based on the value indicating the phase of the polygon P set by the setting unit 24, but may determine both the position of the rotation axis Rt of the rotary tool and the initial phase of the rotary tool T.

It is noted that the present disclosure is not limited to the above-described embodiments, and can be appropriately changed without departing from the gist. In the present disclosure, any component of the embodiments can be modified, or any component of the embodiments can be omitted.

### REFERENCE SIGNS LIST

1 MACHINE TOOL
2 NUMERICAL CONTROLLER
201 HARDWARE PROCESSOR
202 BUS
203 ROM
204 RAM
205 NONVOLATILE MEMORY
206 INTERFACE
207 AXIS CONTROL CIRCUIT
208 SPINDLE CONTROL CIRCUIT
209 PLC
210 I/O UNIT
21 FIRST CONTROL UNIT
22 SECOND CONTROL UNIT
23 THIRD CONTROL UNIT
24 SETTING UNIT
3 INPUT/OUTPUT DEVICE
4 SERVO AMPLIFIER
5 TOOL ROTATION SERVOMOTOR
6 X-AXIS SERVOMOTOR
7 Y-AXIS SERVOMOTOR
8 Z-AXIS SERVOMOTOR
9 SPINDLE AMPLIFIER
10 SPINDLE MOTOR
11 AUXILIARY DEVICE
Cw CENTER AXIS OF WORKPIECE
Cp CENTER AXIS OF POLYGON
Rt ROTATION AXIS OF ROTARY TOOL
Rw ROTATION AXIS OF WORKPIECE

1. A numerical controller comprising:
a first control unit configured to rotate a workpiece around a rotation axis of the workpiece;
a second control unit configured to rotate a rotary tool around a rotation axis of the rotary tool at a rotation speed of a constant ratio with respect to a rotation speed of the workpiece, the rotation axis of the rotary tool being parallel to the rotation axis of the workpiece; and
a third control unit configured to control a relative position between the rotation axis of the rotary tool and a center axis of a polygon so that a positional relationship between the center axis of the polygon and the rotation axis of the rotary tool is kept constant, the center axis of the polygon being parallel to the rotation axis of the workpiece and passing through a predetermined position of the workpiece.

2. The numerical controller according to claim 1, wherein the third control unit identifies a position of the center axis of the polygon with respect to a position of the rotation axis of the workpiece based on a rotation angle of the rotation axis of the workpiece and a distance between the rotation axis of the workpiece and the center axis of the polygon, and determines at least one of an initial position of the rotation axis of the workpiece and an initial position of the rotation axis of the rotary tool so as to allow an initial position of the center axis of the polygon to be disposed on a line segment connecting the initial position of the rotation axis of the workpiece to the initial position of the rotation axis of the rotary tool.

3. The numerical controller according to claim 2, wherein the third control unit controls the relative position between the center axis of the polygon and the rotation axis of the rotary tool by using a feedback value of the rotation angle of the rotation axis of the workpiece.

4. The numerical controller according to claim 1, further comprising a setting unit configured to set a phase of the polygon,
wherein the third control unit determines, based on the phase set by the setting unit, the relative position between the rotation axis of the rotary tool and the center axis of the polygon.

5. The numerical controller according to claim 1, further comprising a setting unit configured to set a phase of the polygon,
wherein the second control unit determines an initial phase of the rotary tool based on the phase set by the setting unit.

6. The numerical controller according to claim 1, wherein the third control unit causes at least one of the rotation axis of the workpiece and the rotation axis of the rotary tool to approach, by cutting feed, a position at which the positional relationship therebetween becomes constant.
